(19) United States
(12) Patent Application Publication
(10) Pub. No.: US 2007/0199866 A1
(43) Pub. Date: Aug. 30, 2007

(54) Mail box mail

(76) Inventor: George C. Littlejohn, Conyers, GA (US)

Correspondence Address: George C. Littlejohn, P.O. Box 82602, Conyers, GA, 30013, US

(21) Appl. No.: 11/705,532

(22) Filed: Feb. 13, 2007

Related U.S. Application Data
(60) Provisional application No. 60/773,159, filed on Feb. 15, 2006.

(51) Int. Cl. B07C 5/00; G06F 17/00; G08B 13/14

(52) U.S. Cl. 209/509; 340/572.1; 235/375

(57) ABSTRACT

A hand held RFID collection device, reads an encoded intergraded electronic product coded data strips. The Coded strips are adhered to mail slots; the coded numerical communicational RDIF tags comprise of a reader and identifier. The machine-readable format processes the collective data of the said reading to generate an interpreter module. The RFID (dual-mode) plurality antenna enable the permanent identification process a certain response from the RF reader to the RF command in response to the RF illuminational field to further configure (program) to perform independently to selective command. The selective command controls are operated by the operator. A switch on the keyboard to enable a response to a corresponding subset of the transponder tags. The total sum of the data is transmitted to a host computer.

### BRIEF SUMMARY OF THE INVENTION

The present invention provided a typical RFID system with a label circuitry transmitting power signal. The power signal conveys data with an electrically connected antenna. The said data memory responds to the program signal and the function of the reading to the RF command.

Furthermore, the two-dimensional data code would include key information to describing the content of the mail in a functioning pre coded on three switches on the keypad to the sublet (4) classification of the mail:
1. Miscellaneous Media (publications, flyers, sales or commonly referred as junk mail)
2. General Mail (postcards, common correspondence, and bills)
3. Confidential Mail (funds, registered mail, dated mail, legal, time related and packages)
4. Packages (gifts, movies, and personal items)

### BACKGROUND OF THE INVENTION

Radio frequency identification tags (RFID TAGS) are utilized in the vast variety of application; inventory control tracking personnel, luggage, pets and security.

For example the arrival of mail U.S. Pat. No. 6,741,178 at a particular location where the scanning tagged mail is used as a receipt or proof of sender of arrival time via a computer system.

Another example the RFID reader uses the wireless hand device (U.S. Pat. No. 6,464,139 October 2002, Wilz) internet-enabled for enabling information/transactions. Additionally, the method and apparatus RFID Tag Reader. U.S. Pat. No. 6,784,789, August 2004 Erogler. Finally, the wireless data input to the RFID reader U.S. Pat. No. 6,828,902, December Casden

Many people are located some distance from their mailbox. This is especially true in our vast suburbs of today. This creates a problem and a great expense of time and money.

The inventor is very much aware of the trips to the mailbox to discover the sender did not forward the mail in a timely fashion as sender stated previously.

It is a main consideration of the present invention to provide an updated answer to an antiquated problem.

### BRIEF DESCRIPTION OF THE DRAWING

FIG. 1 is a flow chart illustrating the operations in accordance with one embodiment of the invention according to said reader FIG. 2 for discovering (i.e. identification) of the RF Tags FIG. 1 each Tag has its own functionality and ID number adhered to each mail slot.

FIG. 2 shows how the RF reader FIG. 2 shows how the reader determines the RF command.

FIG. 3 The hand held device is further enhanced to allow or permit the operator to sublet more vital information in the process of identification FIG. 2 by means of an selective choice FIG. 4 by visual means,

FIG. 4 is a block diagram of the antenna to replenish or eliminate the information via internet, according to the present invention.

FIG. 5 is a block diagram of a system utilized with a method to providing dynamic information via an internet, according to present invention.

### BRIEF DESCRIPTION OF THE DRAWING

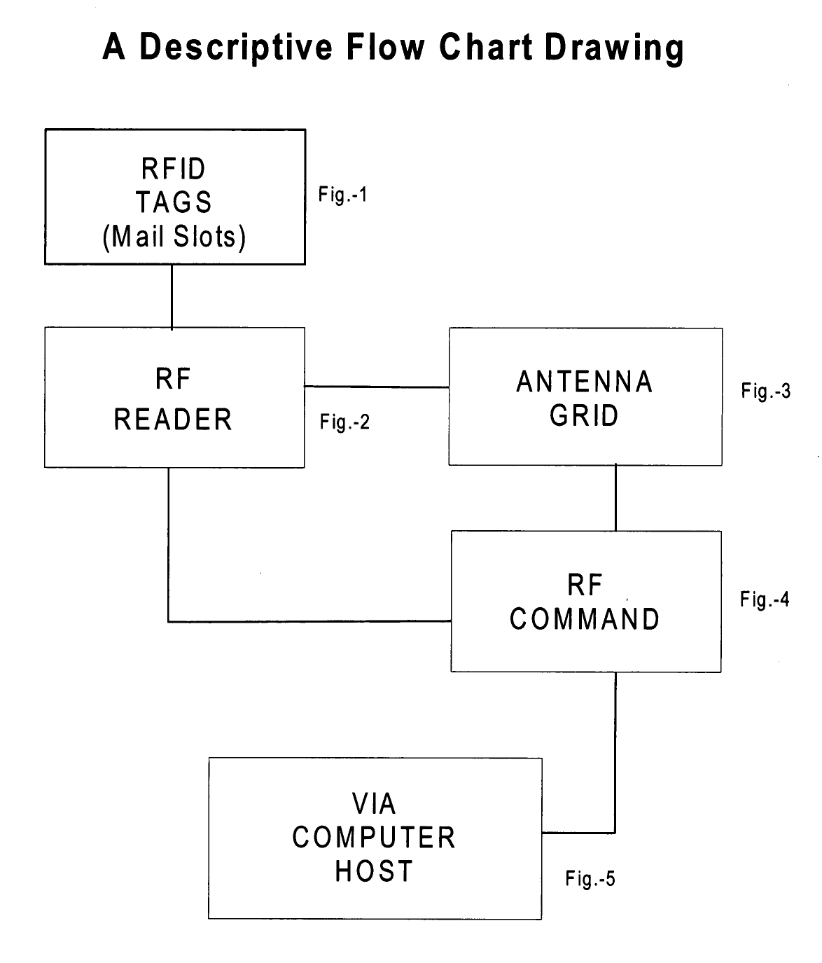

FIG. 1 is a flow chart illustrating the operations in accordance with one embodiment of the invention according to said reader FIG. 2 for discovering (i.e. identification) of the RF Tags FIG. 1 each Tag has its own functionality and ID number adhered to each mail slot.

FIG. 2 shows how the RF reader FIG. 2 shows how the reader determines the RF command.

FIG. 3 The hand held device is further enhanced to allow or permit the operator to sublet more vital information in the process of identification FIG. 2 by means of an selective choice FIG. 4 by visual means,

FIG. 4 is a block diagram of the antenna to replenish or eliminate the information via internet, according to the present invention.

FIG. 5 is a block diagram of a system utilized with a method to providing dynamic information via an internet, according to present invention.

### BRIEF SUMMARY OF THE INVENTION

The present invention provided a typical RFID system with a label circuitry transmitting power signal. The power signal conveys data with an electrically connected antenna. The said data memory responds to the program signal and the function of the reading to the RF command.

Furthermore, the two-dimensional data code would include key information to describing the content of the mail in a functioning pre coded on three switches on the keypad to the sublet (4) classification of the mail:
1. Miscellaneous Media (publications, flyers, sales or commonly referred as junk mail)
2. General Mail (postcards, common correspondence, and bills)
3. Confidential Mail (funds, registered mail, dated mail, legal, time related and packages)
4. Packages (gifts, movies, and personal items)

### BACKGROUND OF THE INVENTION

Radio frequency identification tags (RFID TAGS) are utilized in the vast variety of application; inventory control tracking personnel, luggage, pets and security.

For example the arrival of mail U.S. Pat. No. 6,741,178 at a particular location where the scanning tagged mail is used as a receipt or proof of sender of arrival time via a computer system.

Another example the RFID reader uses the wireless hand device (U.S. Pat. No. 6,464,139 October 2002, Wilz) internet-enabled for enabling information/transactions. Additionally, the method and apparatus RFID Tag Reader. U.S. Pat. No. 6,784,789, August 2004 Erogler. Finally, the wireless data input to the RFID reader U.S. Pat. No. 6,828,902, December Casden

Many people are located some distance from their mailbox. This is especially true in our vast suburbs of today. This creates a problem and a great expense of time and money.

The inventor is very much aware of the trips to the mailbox to discover the sender did not forward the mail in a timely fashion as sender stated previously.

It is a main consideration of the present invention to provide an updated answer to an antiquated problem.

What is claim:

1. A method of monitoring a hand held wireless (RFID) system. Having a data reader (1) and identifier encoded system (2) to work in concert through a pre-determined scope. The RFID is used for the purpose of reading and identifying mail as it is placed in to the mail slots. The said device has an embodiment of receiving and identifying; the circuit is enhanced by an antenna (3) to aide in the transmission of the signals.

2. The method according to claim (1), is performed by a human. The operator has control of the RFID command program (4). The operator has the (4) selective switches (4) to maintain the classification and identity of the mail as it is placed in the mail slots. The said device command switches are affixed for hand operations. The command program consist of four classifications of mail (misc. regular, priority, and packages).

3. It is further claimed that the mailbox recipient (holder) would have the descriptive mail (4) and number of pieces of mail on a daily bases, i.e. (internet email). The mailbox recipient would be given a username and password corresponding to given mailbox.
